(19) United States
(12) Patent Application Publication
(10) Pub. No.: US 2015/0058154 A1
(43) Pub. Date: Feb. 26, 2015

(54) SHOPPING LIST OPTIMIZATION

(71) Applicant: International Business Machines Corporation, Armonk, NY (US)

(72) Inventors: James P. Appleyard, North Richland Hills, TX (US); Hung T. Kwan, Grand Prairie, TX (US); Shiju Mathai, Carrollton, TX (US)

(73) Assignee: International Business Machines Corporation, Armonk, NY (US)

(21) Appl. No.: 13/974,550

(22) Filed: Aug. 23, 2013

(51) Int. Cl. G06Q 30/06

(52) U.S. Cl. CPC G06Q 30/0633; G06Q 30/0611
USPC 705/26.4

(57) ABSTRACT

An optimization server optimizes a shopping list. The server receives a shopping list including a plurality of items to purchase. The server determines a discount to the price of one or more of the plurality of items, a sentiment score for one or more of the plurality of items, and a sentiment score for a retailer of one or more of the plurality of items. The server groups the plurality of items into a plurality of sub-lists, transmits the plurality of sub-lists to a respective plurality of retail servers, and receives a plurality of bids in response. The server generates optimized shopping lists based at least on the discount, the sentiment scores, and the plurality of bids. The server regenerates at least one of the optimized shopping lists based at least on a dynamic discount condition, a dynamic price condition, or a dynamic inventory condition.

### FIELD OF THE INVENTION

The present invention relates generally to optimizing a shopping list of a shopper, and more particularly to providing an online service for the optimization of shopping lists using real-time analytics.

### BACKGROUND

Shoppers commonly research rating and pricing information about goods on the Internet before purchasing the goods. For example, prior to making a purchase of an appliance from an enterprise, a customer can research the appliance to determine its quality, according to numerous aggregated ratings, and what it costs at a number of online and brick-and-mortar retailers, including the enterprise, according to price-comparison websites. Such aggregated ratings can include ratings by professional consumer reporting companies, as well as crowd-sourced nonprofessional raters. Numerous techniques exist for aggregating ratings and for performing online price comparisons. Typically, a shopper having a shopping list can research the goods rating and pricing information for each item on the shopping list separately.

### SUMMARY

Embodiments of the present invention provide for a program product, system, and method to optimize a shopping list. A server receives a shopping list including a plurality of items to purchase. The server determines a discount to the price of one or more of the plurality of items, a sentiment score for one or more of the plurality of items, and a sentiment score for a retailer of one or more of the plurality of items. The server groups the plurality of items into a plurality of sub-lists, transmits the plurality of sub-lists to a respective plurality of retail servers, and receives a plurality of bids in response. The server generates optimized shopping lists based at least on the discount, the sentiment scores, and the plurality of bids. The server regenerates at least one of the optimized shopping lists based at least on a dynamic discount condition, a dynamic price condition, or a dynamic inventory condition.

### BRIEF DESCRIPTION OF THE SEVERAL VIEWS OF THE DRAWINGS

FIG. 1 is a functional block diagram of an optimization environment in accordance with an embodiment of the present invention.

FIG. 2 is a functional block diagram of the optimization environment of FIG. 1 depicting optimizing interactions in accordance with an embodiment of the present invention.

FIG. 3 shows a flowchart depicting steps followed during optimizing interactions in accordance with an embodiment of the present invention.

FIG. 4 is a functional block diagram of a computer system in accordance with an embodiment of the present invention.

### DETAILED DESCRIPTION

According to the techniques introduced herein, a shopper having a shopping list of goods to purchase can submit the shopping list to an optimization server, which performs research, checks multiple retailers to locate the best available deals, and performs other optimizations, to produce an optimized shopping list for the shopper. The optimization server can take a comprehensive view from the shopper perspective to come up with recommendations and optimizations. Factors such as consumer sentiment on products or retailers, customer loyalty, customer preferences, buying patterns, location awareness, and environmental impact, for example, can be considered together or separately by the optimization server. Further, the optimization server can use real-time analytics associated with a collection of factors to provide the best combination of recommendations and optimizations to the shopper. The techniques introduced herein can be applied to retail shopping, wholesale shopping, car buying, insurance quote shopping, or any other kind of activity amenable to optimization.

Further according to the techniques introduced herein, a shopper can register and then submit a shopping list to an optimization server. The goods on the shopping list are accessed and analyzed by the optimization server. In particular, for each item on the shopping list, the optimization server queries all known data sources (e.g., retailers, service providers, manufactures, etc.) to retrieve available discounts for the item. The shopping list is then segmented into multiple sublists per retailer, based on the discounts, sentiment score by retailer, and product. Each sublist is submitted to one or more retailers for bidding in conjunction with other information such as customer loyalty identification, for example. The resulting bids from all retailers are scored and ranked by the optimization server in conjunction with factors such as buying patterns, optimal route based on location information, and environmental impact, for example. The ranked shopping recommendations are then sent to the shopper. Subsequent buying decisions from the shopper are fed back into the optimization server for improved future shopping recommendations.

Accordingly, the techniques introduced herein can save time, enhance the shopping experience based on real-time information from a comprehensive set of factors, and improve shopper satisfaction. The techniques introduced herein can use a comprehensive set of factors including retailers, consumers buying patterns, preferences, consumer sentiments, and environmental impact to enhance the shopping experience. The ability to segment the shopping list and take advantage of discounts from multiple retailers further improves results. Further, the ability to learn from shopper buying decisions to enhance the future shopping experiences (i.e., self-learning) further enhances the shopping experience.

Further according to the techniques introduced herein, when a request is submitted to an optimization server, a discovery engine can be used to discover all possible discounts, and a ranking engine can be used to analyze the comprehensive set of real-time factors such as preferences, retailers pricing, discounts, buying patterns, rating, consumer sentiments, environmental impact, and other criteria that are set. Further refinement can be done based on shopper location, environmental impact, and commuting route, for example. Usage of self-learning patterns to record the historical shopping decisions and further analyze the decision pattern and use it in further analysis is also an option. Accordingly, shoppers can have the best available recommendations in real time, and merchants, retailers, and sellers can have an ability to investigate and give instant discounts or offers to individual product requests.

Further according to the techniques introduced herein, the ranking can be based on cost, quantity, incentives, retailers rating, location, sentiments, or time. Each shopper can have different preferences and further refinement can be done by a ranking engine. Retailers can request the carbon footprint of the products they sell, and when the optimization server receives the retailer's bid it can use the carbon footprint to further refine the search results. Accordingly, the optimization engine can take a complex request and intelligently break it into a bundle of requests to be optimized. Carbon footprint can be calculated and used as factor for analysis and optimization. Further, the carbon footprint is not limited to just a given product's carbon footprint, but also relates to the carbon footprint generated by the shopper and the retailer (e.g., the carbon footprint involved with shipping, transportation, and customer pickup, etc.). Generally, the optimization engine can generate an optimized shopping list based on the proximity of a brick-and-mortar retailer to a shopper, to offset a carbon footprint by directing the shopper to the brick-and-mortar retailer. Merchants, retailers, and sellers can have the ability to investigate and give instant discounts or offers to individual product requests. Optimizations can be continued on a regular basis until they have been closed or expired. Requests can proactive (i.e., the optimization server can provide a “living search”). Prices, inventory, and discounts can be dynamic. Using a mobile device, the optimization engine can learn the location of the shopper (e.g., using a GPS sensor of the mobile device, etc.), and the shopper can receive ranked results including proximity searches that are done to alert the shopper of better deals nearby that are in the shopping list.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

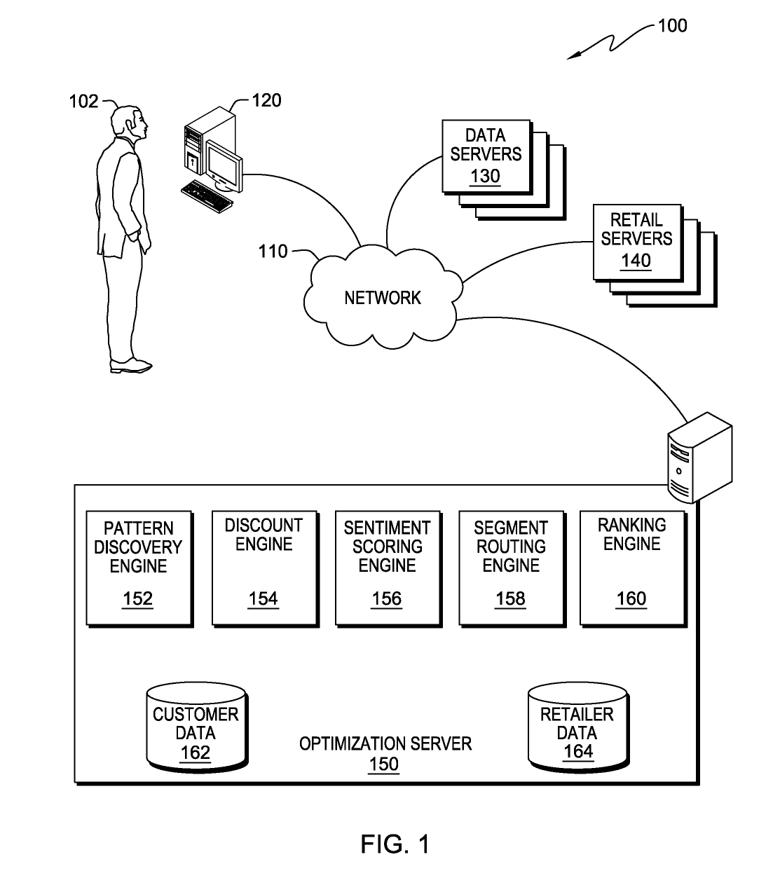

Referring now to FIG. 1, a functional block diagram of optimization environment 100 in accordance with an embodiment of the present invention is shown. Optimization environment 100 includes network 110, user computer 120, data servers 130, retail servers 140, and optimization server 150. As discussed in detail below, person 102 can submit a shopping list of goods to purchase to optimization server 150 and receive an optimized shopping list from optimization server 150. As further discussed in detail below, optimization server 150 generates the optimized shopping list through optimizing interactions with data servers 130 and retail servers 140.

Network 110 can be, for example, a local area network (LAN), a wide area network (WAN) such as the Internet, or a combination of the two, and can include wired or wireless connections. In general, network 110 can be any combination of connections and protocols that will support communications via various channels between user computer 120, data servers 130, retail servers 140, and optimization server 150 in accordance with an embodiment of the invention.

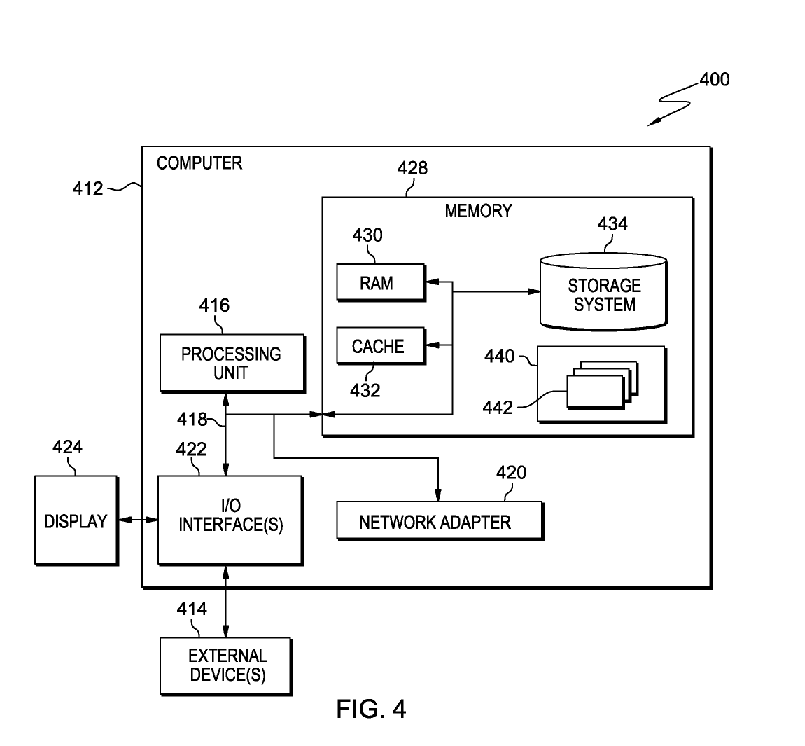

In various embodiments, each of user computer 120 and optimization server 150, as well as each one of data servers 130 and retail servers 140, can include a laptop, tablet, or netbook personal computer (PC), a desktop computer, a personal digital assistant (PDA), a smart phone, a mainframe computer, or a networked server computer. Further, data servers 130, retail servers 140, and optimization server 150 can include computing systems utilizing clustered computers and components to act as single pools of seamless resources when accessed through network 110, or can represent one or more cloud computing datacenters. In general, each of user computer 120 and optimization server 150, as well as each one of data servers 130 and retail servers 140, can be any programmable electronic device as described in further detail with respect to FIG. 4.

User computer 120 includes software, such as a web browser program, for interacting with optimization server 150, and optionally with one or more of data servers 130 and retail servers 140, via network 110. For example, optimization server 150 can host an optimization web page viewable on the web browser program of user computer 120. The web browser program of user computer 120 can load the optimization web page from optimization server 150, to enable person 102 to submit a shopping list of goods to purchase to optimization server 150, and receive an optimized shopping list from optimization server 150. In particular, person 102 can enter a shopping list of goods to purchase into a text input form of the loaded optimization web page displayed by the web browser program, and the web browser program can transmit the shopping list of goods to purchase to optimization server 150. Subsequently, optimization server 150 can generate an optimized shopping list and transmit the optimized shopping list to user computer 120, for display to person 102, as discussed in detail below.

Data servers 130 include one or more servers hosting reviews, feedback, or other sentiment data about goods available for purchase, about retailers, or both. For example, data servers 130 can include recall databases, service bulletin databases, product comment web pages, social media platforms, and other structured or unstructured data repositories about goods available for purchase and retailers. In the case of social media platforms, data servers 130 can include servers hosting or providing access (e.g., through a public API, etc.) to social networks. Each such social media platform provides its members with the ability to make social media posts about goods available for purchase. Members can be people, corporations, or other entities. Further, a social media platform of data servers 130 may provide access to a member's history of past social media posts. When a member of a social media platform makes a new social media post, the new social media post is appended to the member's history, and also made public, or semi-public, depending on privacy settings stored in the member's profile. Generally, a social media post can include text or other media (e.g., a picture, etc.). As will be discussed in detail below, optimization server 150 can interact with data servers 130 to gather information about goods in a shopping list received from user computer 120, and about relevant retailers, during the generation of an optimized shopping list.

Retail servers 140, each owned or controlled by an enterprise involved in the sale of goods, includes one or more servers that receive submissions for bidding from optimization server 150, and that provide bids to optimization server 150. A submission for bidding includes a request for a bid to sell one or more goods (e.g., one or more goods on a shopping list or a segment of a shopping list, etc.), and a bid includes an offer to sell the one or more goods at a stated price. Many different enterprises selling goods of all kinds can be involved in the ownership or control of one or more of retail servers 140. Each such enterprise can be any enterprise involved in selling, or making available for sale, goods of any type, either online or through a traditional brick-and-mortar retail establishment. For example, a first online-only retailer may own several hundred of retail servers 140, while a second brick-and-mortar retail establishment may control just one of retail servers 140, while a third online-and-brick-and-mortar retailer may own another dozen of retail servers 140. Such enterprises can be retailers of clothes, appliances, electronics, hardware, software, prepared meals, or any other goods that have economic utility or that satisfy an economic want, or anything grown, manufactured, or produced for sale. As will be discussed in detail below, optimization server 150 can interact with retail servers 140 to make submissions for bidding and to receive bids, during the generation of an optimized shopping list.

Optimization server 150 includes pattern discovery engine 152, discount engine 154, sentiment scoring engine 156, segment routing engine 158, ranking engine 160, customer data 162, and retailer data 164. Customer data 162 contains information of registered shoppers, associated loyalty programs with retailers, shopper historical buying decisions, and other information as discussed below. Retailer data 164 includes contains information of retailers that participate in optimization interactions, and other information as discussed below. As discussed in detail below, optimization server 150 can receive a shopping list of goods to purchase from user computer 120, can generate an optimized shopping list during optimizing interactions between engines 152 through 160 and data servers 130 and retail servers 140 using data in customer data 162 and retailer data 164, and can transmit the optimized shopping list to user computer 120.

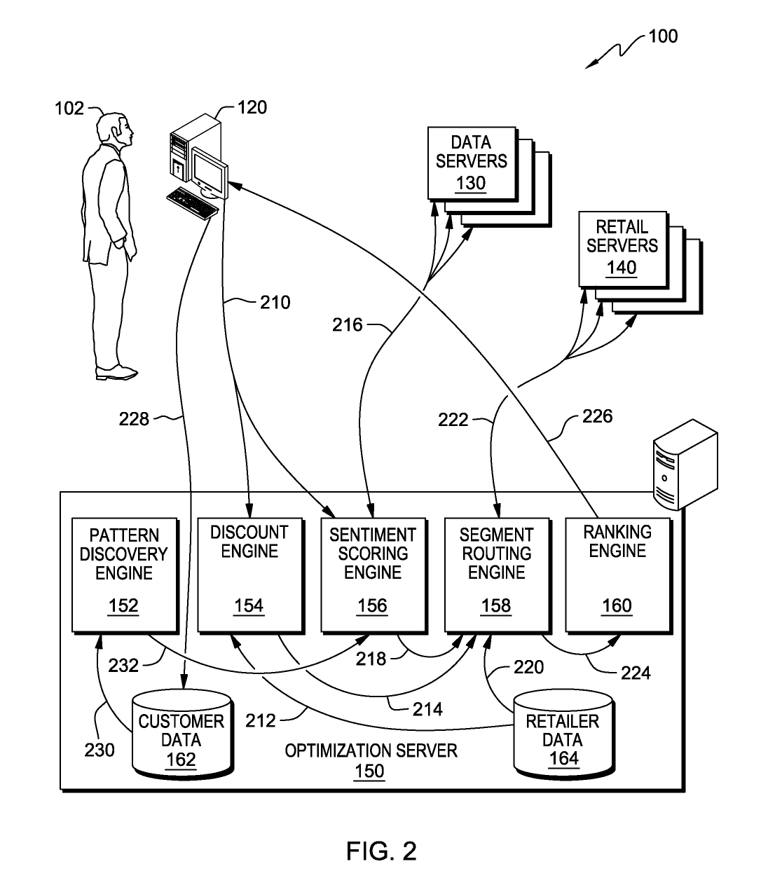

The operation of engines 152 through 160 will be discussed in detail in the context of FIG. 2, below. Briefly, pattern discovery engine 152 uses the historical shopping decisions made by a shopper, such as person 102, to analyze the decision pattern of the shopper and to use the pattern as input to sentiment scoring engine 156, to further enhance the shopping experience of the shopper. Discount engine 154 analyzes each item on the shopping list and searches for possible discount offerings from various brands, manufacturers, or retailers (e.g., data servers 130 and retail servers 140, etc.) to compile a list of possible discounts that may be applied to the items. Sentiment scoring engine 156 analyzes each item on a shopping list, searches for reviews or buyer's feedback from multiple relevant data sources (e.g., data servers 130, etc.), and computes a sentiment score for each item and for each retailer. Segment routing engine 158 groups items on a shopping list, based on discount information (e.g., as provided by discount engine 154, etc.) and the customer sentiment scores (e.g., as provided by sentiment scoring engine 156, etc.), into shopping sub-lists and submits the shopping sub-lists to retailers for bidding (e.g., submits to retail servers 140, etc.). Ranking engine 160 aggregates shopping sub-list bids received from retailers, analyzes the results, and generates one or more optimized shopping lists that fulfill the shopper's requirements. Each of these optimized shopping lists can include one or more brick-and-mortar or online retailers and items that the shopper should purchase from each. Each of the optimized shopping lists is optimized and ranked based on the shopper's preferences, the retailer and item sentiment scores, and the item's pricing. The optimization can further be refined based on a shopper's location (e.g., brick-and-mortar retailers in the shopper's neighborhood, or on the shopper's normal commuting route between work and home, can be given priority, etc.).

Referring now to FIG. 2, a functional block diagram of optimization environment 100 of FIG. 1 depicting optimizing interactions 210 through 232 in accordance with an embodiment of the present invention is shown. Although the depiction of network 110 is omitted from FIG. 2, it should be understood that each of optimizing interactions 210 through 232 can entail one or more communications over network 110. It should further be understood that the present invention is not limited to optimizing interactions 210 through 232, and that additional interactions can be practiced.

During optimizing interaction 210, a web browser program of user computer 120 transmits a shopping list of goods to purchase to optimization server 150. Person 102 can enter the shopping list of goods to purchase into a text input form of an optimization web page displayed by the web browser program prior to optimizing interaction 210. At the conclusion of optimizing interaction 210, the shopping list is transmitted to both of discount engine 154 and sentiment scoring engine 156.

Following optimizing interaction 210, at discount engine 154 optimizing interactions 212 and 214 occur. Discount engine 154 analyzes each item on the received shopping list and searches for possible discount offerings from various brands, manufacturers, or retailers to compile a list of possible discounts that may be applied to the items. In particular, during optimizing interaction 212 discount engine 154 retrieves discount offerings stored in retailer data 164. Discount engine 154 can also search for discount offerings on data servers 130 and retail servers 140. Each item on the shopping list might receive no discount, one discount, or multiple discounts (e.g., multiple discounts from a single retailer, or multiple discounts from different retailers, etc.). Having searched for possible discount offerings, discount engine 154 performs optimizing interaction 214, during which the shopping list and associated discounts are transmitted to segment routing engine 158.

Also following optimizing interaction 210, at sentiment scoring engine 156 optimizing interactions 216, 232, and 218 occur. Sentiment scoring engine 156 analyzes each item on the received shopping list, searches for reviews or feedback of items or retailers from multiple relevant data sources, and computes a sentiment score for each item, for the item or for its associated retailer, or both. In particular, sentiment scoring engine 156 performs optimizing interaction 216 by querying data servers 130 for factors including, but not necessarily limited to, consumer sentiment on products or retailers, customer loyalty, customer preferences, buying patterns, and environmental impact. Further, sentiment scoring engine 156 performs optimizing interaction 232 by querying pattern discovery engine 152 for factors including, but not necessarily limited to, the consumer sentiment of person 102 on products or retailers, customer loyalty of person 102, customer preferences of person 102, buying patterns of person 102, and environmental considerations for person 102. Thus, it can be noted that during optimizing interaction 216, sentiment scoring engine 156 is focused on extrinsic data available on numerous external sources, while during optimizing interaction 232, sentiment scoring engine 156 is focused on intrinsic data available from pattern discovery engine 152 (the operation of pattern discovery engine 152 will be covered below in a discussion of optimizing interactions 228, 230, and 232).

Following optimizing interactions 216 and 232 sentiment scoring engine 156 performs optimizing interaction 218, during which the received shopping list and associated sentiment scores are transmitted to segment routing engine 158. In particular, sentiment scoring engine 156 associates each item on the received shopping list with a sentiment score. Each sentiment score can relate to how an associated item is perceived in terms of popularity or quality, for example. Each sentiment score can further relate to how a retailer selling an associated item is perceived in terms of popularity or quality, for example.

Following optimizing interactions 214 and 218, at segment routing engine 158 optimizing interactions 220, 222 and 224 occur. Segment routing engine 158 groups items on the shopping list into shopping sub-lists, based on discount information provided by discount engine 154 and sentiment scores provided by sentiment scoring engine 156, and submits the shopping sub-lists to retailers for bidding. Notably, because in one embodiment segment routing engine 158 receives the shopping list during each of optimizing interactions 214 and 218, segment routing engine 158 can perform a deduplication and integration task initially, to produce an integrated shopping list that includes all determined discounts and sentiment scores associate with the items on the shopping list. Subsequently, segment routing engine 158 performs optimizing interaction 220 by looking up each item on the integrated shopping list in retailer data 164, and retrieving retailer contact information (e.g., the network address on network 110, etc.) of each retailer selling the respective item. Having retrieved retailer contact information, segment routing engine 158 groups items on the shopping list into shopping sub-lists.

Segment routing engine 158 can group items on the shopping list into shopping sub-lists in several ways. For example, in one embodiment segment routing engine 158 can group items into maximal-coverage shopping sub-lists, such that each item is submitted for bidding to every retailer that sells the item (e.g., if two retailers sell a given item, the given item will be included on a first sub-list sent to the first retailer, as well as on a second sub-list sent to the second retailer, etc.). By this technique, greater network traffic and retailer bidding resources will be consumed, but more bids will ultimately be generated. By this technique it is likely that multiple bids per item will be generated (e.g., two retailers may make separate bids for the same item, if the item is duplicated in both shopping sub-lists). In another embodiment, segment routing engine 158 can group items into minimal-coverage shopping sub-lists, such that each item is submitted for bidding to at most one retailer. By this technique, less network traffic and retailer bidding resources will be consumed, and fewer bids will ultimately be generated. By this technique at most one bid per item will be generated. In this embodiment, the selection of retailers who will receive submissions for bidding with minimal-coverage shopping sub-lists can entail selecting only retailers having sentiment scores that exceed a minimum threshold, or that are higher than competing retailers that sell the same item, for example. Having retrieved retailer contact information and grouped items on the shopping list into shopping sub-lists, segment routing engine 158 submits the shopping sub-lists to retailers for bidding during optimizing interaction 222, by transmitting each shopping sub-list to a respective one or more of retail servers 140.

At the conclusion of optimizing interaction 222, segment routing engine 158 receives a bid on each shopping sub-list from retail servers 140. In one embodiment, a bid is a simple total price for the entire shopping sub-list, while in another embodiment the bid is a list of prices for each item on the shopping sub-list. If, for some reason, a bid is not received from a particular retailer, segment routing engine 158 can recover in several ways. If maximal-coverage shopping sub-lists had been generated, and at least one of retailer servers 140 responded for every item, segment routing engine 158 can proceed with a non-maximal, but still comprehensive, number of bids (i.e., can still proceed as long as every item has at least one bid). If minimal-coverage shopping sub-lists had been generated, and at least one item has no bid at all, segment routing engine 158 can regenerate a new minimal-coverage shopping sub-list that sends the bidless item to a different one of retail servers 140 for bidding. Ultimately, if after recovery attempts have been made no retailer bids on a given item, segment routing engine 158 can proceed with a reduced shopping list (i.e., person 102 will ultimately receive an optimized shopping list that does not include the bidless item). During optimizing interaction 224, segment routing engine 158 transmits the shopping list and bids to ranking engine 160.

Following optimizing interaction 224, at ranking engine 160 optimizing interaction 226 occurs. Ranking engine 160 aggregates shopping sub-list bids received during optimizing interaction 224, analyzes the results, and generates one or more optimized shopping lists for person 102. Each of the optimized shopping lists can include one or more brick-and-mortar or online retailers and items that person 102 should purchase from each. Each of the optimized shopping lists is optimized and ranked based on the preferences of person 102, the retailer and item sentiment scores, the item pricing, and other factors. For example, ranking engine 160 can balance the interest of person 102 in receiving the lowest possible price against the interest in person 102 in frequenting retailers that deliver the best customer experience, depending on the preference of person 102 for one or the other. The optimization can further be refined based on the location of person 102 and the retailers. For example, ranking engine 160 can account for the distance between person 102 and the brick-and-mortar retailers, on the normal commuting route between work and home of person 102, the shipping time or distance between person 102 and a distribution center of an online retailer, and other factors. During optimizing interaction 226, ranking engine 160 transmits the one or more optimized shopping lists to user computer 120.

In one embodiment, optimizing interaction 226 is repeated by ranking engine 160 in response to dynamically changing conditions. For example, in response to dynamic discount conditions, ranking engine 160 can receive updated discount information from discount engine 154 via segment routing engine 158 (i.e., via repeated optimizing interactions 214 and 224). Having received the updated discount information, ranking engine 160 can regenerate one or more optimized shopping lists for person 102 and retransmit them in a repeated optimizing interaction 226. For another example, in response to dynamic price or inventory conditions, ranking engine 160 can receive updated price or inventory information from segment routing engine 158 (i.e., via repeated optimizing interactions 222 and 224). Having received the updated price or inventory information, ranking engine 160 can regenerate one or more optimized shopping lists for person 102 and retransmit them in a repeated optimizing interaction 226.

Following optimizing interaction 226, at user computer 120 person 102 can review the one or more optimized shopping lists and select one to perform. Further, person 102 can also modify the selected optimized shopping list by adding or removing one or more items. While person 102 performs the selected optimized shopping list (e.g., by walking, driving, or taking public transportation to a brick and mortar retailer, or by making online purchases, or both, etc.), during optimizing interaction 228 user computer 120 transmits the selected optimized shopping list (as modified by person 102, if applicable) to optimization server 150, where it is stored with customer preferences and other data in customer data 162. Person 102 thereby receives the benefit of shopping with the selected optimized shopping list, while optimization server 150 thereby receives the benefit of learning which of the optimized shopping lists was selected for performance, and what modifications person 102 made to it (if any).

Following optimization interaction 228, at pattern discovery engine 152 optimizing interactions 230 and 232 occur. Pattern discovery engine 152 uses the historical shopping decisions made by person 102 to analyze the decision pattern of person 102 and to use the pattern as input to sentiment scoring engine 156, to further enhance the shopping experience of person 102. In particular, pattern discovery engine 152 can perform optimizing interaction 230 to pull data regarding person 102, including recent data about which optimized shopping list was selected for performance by person 102, and what modifications person 102 made to it. Using the selection and modification data, pattern discovery engine 152 can refine a model of person 102 that includes the preferences of person 102. For example, if person 102 selected an optimized shopping list that had the lowest environmental impact (e.g., had the lowest carbon footprint for transit required by person 102, for production consequences of the shopping list items, and for transit required by retailers to move the items of the shopping list to a nearby brick-and-mortar retailer or to the residence of person 102, etc.), then pattern discovery engine 152 can increase the weight given to environmental considerations for person 102. For another example, if person 102 selected an optimized shopping list that gave precedence to a particular retailer, or precedence to a particular retailer mode (e.g., brick-and-mortar versus online, etc.), then pattern discovery engine 152 can increase the weight given to the retailer or the retailer mode for person 102. These examples are not limiting, and it should be understood that pattern discovery engine 152 can increase the weight given to any consideration derived from the selection and modification data related to person 102. Subsequently, during a following occasion of optimizing interaction 210, pattern discovery engine 152 can again be called upon by sentiment scoring engine 156 to provide such insight during optimizing interaction 232.

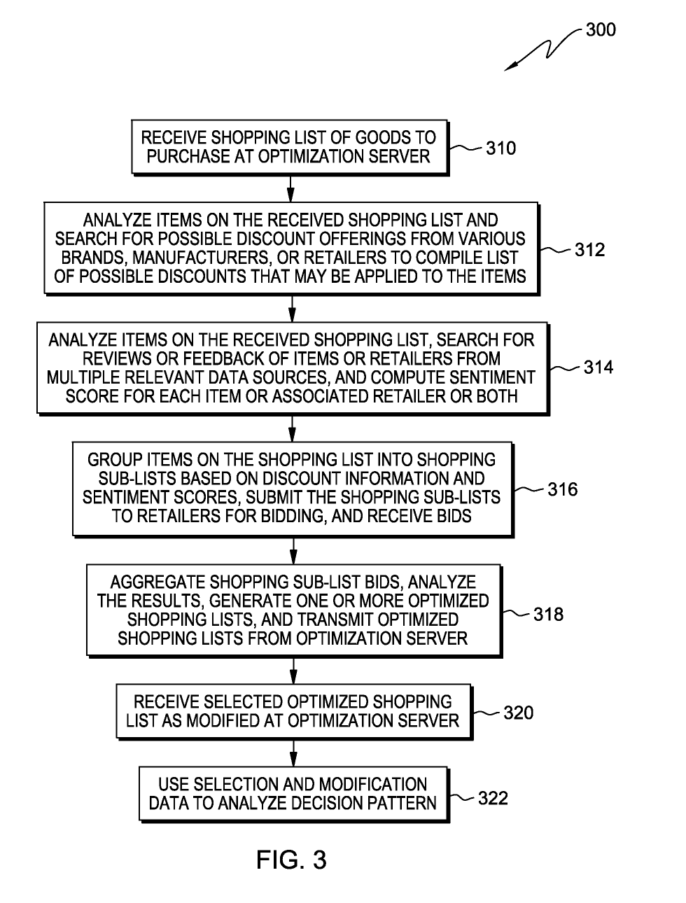

Referring now to FIG. 3, flowchart 300 depicting steps followed during optimizing interactions 210 through 232 in accordance with an embodiment of the present invention is shown. During step 310, discount engine 154 and sentiment scoring engine 156 receive a shopping list of goods to purchase at optimization server 150 from user computer 120 (e.g., optimizing interaction 210, etc.). During step 312, discount engine 154 analyzes items on the received shopping list and searches for possible discount offerings from various brands, manufacturers, or retailers to compile a list of possible discounts that may be applied to the items (e.g., optimizing interactions 212, 214, etc.). During step 314, sentiment scoring engine 156 analyzes items on the received shopping list, searches for reviews or feedback of items or retailers from multiple relevant data sources, and computes sentiment scores for each item or associated retailer or both (e.g., optimizing interactions 216, 232, 218, etc.). During step 316, segment routing engine 158 groups items on the shopping list into shopping sub-lists based on discount information and sentiment scores, submits the shopping sub-lists to retailers for bidding, and receives bids (e.g., optimizing interactions 220, 222, etc.). During step 318, ranking engine 160 aggregates shopping sub-list bids, analyzes the results, generates one or more optimized shopping lists, and transmits the optimized shopping lists from optimization server 150 to user computer 120 (e.g., optimizing interactions 224, 226, etc.). During step 320, customer data 162 receives the selected optimized shopping list as modified (if applicable) at optimization server 150 (e.g., optimizing interaction 228, etc.). During step 322, pattern discovery engine 152 uses the selection and modification data to analyze the decision pattern of shopper 102 (e.g., optimizing interactions 230, 232, etc.).

Referring now to FIG. 4, a functional block diagram of a computer system in accordance with an embodiment of the present invention is shown. Computer system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove.

In computer system 400 there is computer 412, which is operational with numerous other general purpose or special purpose computing system environments or configurations. Examples of well-known computing systems, environments, and/or configurations that may be suitable for use with computer 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of user computer 120, data servers 130, retail servers 140, and optimization server 150 can include or can be implemented as an instance of computer 412.

Computer 412 may be described in the general context of computer system executable instructions, such as program modules, being executed by a computer system. Generally, program modules may include routines, programs, objects, components, logic, data structures, and so on that perform particular tasks or implement particular abstract data types. Computer 412 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 4, computer 412 in computer system 400 is shown in the form of a general-purpose computing device. The components of computer 412 may include, but are not limited to, one or more processors or processing units 416, memory 428, and bus 418 that couples various system components including memory 428 to processing unit 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 412 typically includes a variety of computer system readable media. Such media may be any available media that is accessible by computer 412, and includes both volatile and non-volatile media, and removable and non-removable media.

Memory 428 can include computer system readable media in the form of volatile memory, such as random access memory (RAM) 430 and/or cache 432. Computer 412 may further include other removable/non-removable, volatile/non-volatile computer system storage media. By way of example only, storage system 434 can be provided for reading from and writing to a non-removable, non-volatile magnetic media (not shown and typically called a “hard drive”), upon which customer data 162 and retailer data 164 can be stored. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program 440, having one or more program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein. Each one of pattern discovery engine 152, discount engine 154, sentiment scoring engine 156, segment routing engine 158, and ranking engine 160 can be implemented as or can be an instance of program 440.

Computer 412 may also communicate with one or more external devices 414 such as a keyboard, a pointing device, etc., as well as display 424; one or more devices that enable a user to interact with computer 412; and/or any devices (e.g., network card, modem, etc.) that enable computer 412 to communicate with one or more other computing devices. Such communication can occur via Input/Output (I/O) interfaces 422. Still yet, computer 412 can communicate with one or more networks such as a local area network (LAN), a general wide area network (WAN), and/or a public network (e.g., the Internet) via network adapter 420. As depicted, network adapter 420 communicates with the other components of computer 412 via bus 418. It should be understood that although not shown, other hardware and/or software components could be used in conjunction with computer 412. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for optimizing a shopping list, the method comprising the steps of:
a computer receiving a shopping list including a plurality of items to purchase;
the computer determining a discount to the price of one or more of the plurality of items;
the computer determining a sentiment score for one or more of the plurality of items;
the computer determining a sentiment score for a retailer of one or more of the plurality of items;
the computer grouping the plurality of items into a plurality of sub-lists;
the computer transmitting the plurality of sub-lists to a respective plurality of retail servers;
the computer receiving a plurality of bids from the respective plurality of retail servers; and
the computer generating one or more optimized shopping lists based at least on the discount, the sentiment score for the one or more of the plurality of items, the sentiment score for the retailer of one or more of the plurality of items, and the plurality of bids.

2. The method of claim 1, further comprising the steps of:
the computer transmitting the one or more optimized shopping lists to a user computer;
the computer receiving a selection of one of the one or more optimized shopping lists from the user computer;
the computer receiving a modification of one of the one or more optimized shopping lists from the user computer; and
the computer updating a user preference based on one or more of the selection or the modification.

3. The method of claim 2, wherein the user preference includes one or more of an environmental impact preference, a price preference, a retailer preference, or a retailer mode preference.

4. The method of claim 1, wherein the grouping the plurality of items into a plurality of sub-lists includes grouping the plurality of items into a maximal-coverage sub-list or a minimal-coverage sub-list.

5. The method of claim 1, wherein the generating one or more optimized shopping lists is further based at least on the proximity of a brick-and-mortar retailer to a shopper, and wherein at least one of the one or more optimized shopping lists offsets a carbon footprint by directing the shopper to the brick-and-mortar retailer.

6. The method of claim 1, further comprising regenerating at least one of the one or more optimized shopping lists based at least on a dynamic discount condition, a dynamic price condition, or a dynamic inventory condition.

7. The method of claim 6, wherein the regenerating continues until the computer receives a selection or a modification of at least one of the one or more optimized shopping lists from a user computer.

8. A computer program product for optimizing a shopping list, the computer program product comprising:
one or more computer-readable tangible storage devices and program instructions stored on at least one of the one or more storage devices, the program instructions comprising:
program instructions to receive a shopping list including a plurality of items to purchase;
program instructions to determine a discount to the price of one or more of the plurality of items;
program instructions to determine a sentiment score for one or more of the plurality of items;
program instructions to determine a sentiment score for a retailer of one or more of the plurality of items;
program instructions to group the plurality of items into a plurality of sub-lists;
program instructions to transmit the plurality of sub-lists to a respective plurality of retail servers;
program instructions to receive a plurality of bids from the respective plurality of retail servers; and
program instructions to generate one or more optimized shopping lists based at least on the discount, the sentiment score for the one or more of the plurality of items, the sentiment score for the retailer of one or more of the plurality of items, and the plurality of bids.

9. The computer program product of claim 8, further comprising:
program instructions to transmit the one or more optimized shopping lists to a user computer;
program instructions to receive a selection of one of the one or more optimized shopping lists from the user computer;
program instructions to receive a modification of one of the one or more optimized shopping lists from the user computer; and
program instructions to update a user preference based on one or more of the selection or the modification.

10. The computer program product of claim 9, wherein the user preference includes one or more of an environmental impact preference, a price preference, a retailer preference, or a retailer mode preference.

11. The computer program product of claim 8, wherein grouping the plurality of items into a plurality of sub-lists includes grouping the plurality of items into a maximal-coverage sub-list or a minimal-coverage sub-list.

12. The computer program product of claim 8, wherein generating one or more optimized shopping lists is further based at least on the proximity of a brick-and-mortar retailer to a shopper, and wherein at least one of the one or more optimized shopping lists offsets a carbon footprint by directing the shopper to the brick-and-mortar retailer.

13. The computer program product of claim 8, further comprising program instructions to regenerate at least one of the one or more optimized shopping lists based at least on a dynamic discount condition, a dynamic price condition, or a dynamic inventory condition.

14. The computer program product of claim 13, wherein regenerating continues until a selection or a modification of at least one of the one or more optimized shopping lists is received.

15. A system for optimizing a shopping list, the system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a shopping list including a plurality of items to purchase;
program instructions to determine a discount to the price of one or more of the plurality of items;
program instructions to determine a sentiment score for one or more of the plurality of items;
program instructions to determine a sentiment score for a retailer of one or more of the plurality of items;
program instructions to group the plurality of items into a plurality of sub-lists;
program instructions to transmit the plurality of sub-lists to a respective plurality of retail servers;
program instructions to receive a plurality of bids from the respective plurality of retail servers; and
program instructions to generate one or more optimized shopping lists based at least on the discount, the sentiment score for the one or more of the plurality of items, the sentiment score for the retailer of one or more of the plurality of items, and the plurality of bids.

16. The system of claim 15, further comprising:
program instructions to transmit the one or more optimized shopping lists to a user computer;
program instructions to receive a selection of one of the one or more optimized shopping lists from the user computer;
program instructions to receive a modification of one of the one or more optimized shopping lists from the user computer; and
program instructions to update a user preference based on one or more of the selection or the modification.

17. The system of claim 16, wherein the user preference includes one or more of an environmental impact preference, a price preference, a retailer preference, or a retailer mode preference.

18. The system of claim 15, wherein grouping the plurality of items into a plurality of sub-lists includes grouping the plurality of items into a maximal-coverage sub-list or a minimal-coverage sub-list.

19. The system of claim 15, wherein generating one or more optimized shopping lists is further based at least on the proximity of a brick-and-mortar retailer to a shopper, and wherein at least one of the one or more optimized shopping lists offsets a carbon footprint by directing the shopper to the brick-and-mortar retailer.

20. The system of claim 15, further comprising program instructions to regenerate at least one of the one or more optimized shopping lists based at least on a dynamic discount condition, a dynamic price condition, or a dynamic inventory condition.
